(19) United States
(12) Patent Application Publication
(10) Pub. No.: US 2025/0370081 A1
(43) Pub. Date: Dec. 4, 2025

(54) SYSTEM, METHOD, COMPUTER PROGRAM AND COMPUTER-READABLE MEDIUM

(71) Applicant: FRIEDRICH-ALEXANDER-UNIVERSITÄT ERLANGEN-NÜRNBERG, Erlangen (DE)

(72) Inventors: Stefan BRÜCKNER, Nürnberg (DE); Björn ESKOFIER, Erlangen (DE); Erik SIPPEL, Tennenlohe (DE); Martin VOSSIEK, Fürth (DE)

(21) Appl. No.: 18/876,641

(22) PCT Filed: Jul. 5, 2023
(86) PCT No.: PCT/EP2023/068608

§ 371 Date: Dec. 18, 2024

(30) Foreign Application Priority Data
Jul. 5, 2022 (DE) 10 2022 116 739.9

(51) Int. Cl. G01S 1/08; G01S 1/04

(52) U.S. Cl. CPC G01S 1/08; G01S 1/047

(57) ABSTRACT

The present invention relates to a system for determining the position, the orientation and/or the movement of a beacon, said system comprising at least one receiver and one beacon, the beacon comprising a transmitter, the transmitter of the beacon being designed to emit electromagnetic waves in a frequency band and the receiver having means which are designed to receive the waves and to determine a position, orientation and/or movement of the beacon therefrom, the system having at least one further beacon, the frequency band of the transmitter of the further beacon or the frequency bands of the transmitters of the further beacons differing from the frequency band of the transmitter of the beacon.

### CROSS REFERENCE TO RELATED APPLICATIONS

The present application is a U.S. National Phase of International Application No. PCT/EP2023/068608 entitled “SYSTEM, METHOD, COMPUTER PROGRAMME, AND COMPUTER-READABLE MEDIUM,” and filed on Jul. 5, 2023. International Application No. PCT/EP2023/068608 claims priority to German Patent Application No. 10 2022 116 739.9 filed on Jul. 5, 2022. The entire contents of each of the above-listed applications are hereby incorporated by reference for all purposes.

### TECHNICAL FIELD

The present invention relates to a system for determining the position, the orientation and/or the movement of a beacon, said system having at least one receiver and one beacon, wherein the beacon comprises a transmitter, wherein the transmitter of the beacon is designed to emit electromagnetic waves in a frequency band and the receiver has means designed to receive the waves and to determine a position, orientation and/or movement of the beacon therefrom.

### BACKGROUND AND SUMMARY

It is known in the prior art to locate transmitters by transmitting a short pulse of an ultra-wideband (UWB) signal with a signal power on a broad spectrum, which allows a distance to the transmitter to be determined.

This method has the disadvantage that when locating a plurality of transmitters, their signals overlap in the frequency range, which means that any assignment of the signals involves considerable effort.

Similarly, the signals in this method are only used for distance measurement and no further use of these signals is possible, e.g. for transmitting data.

Separating the signals of a plurality of transmitters, for example by time-interleaving, also has many disadvantages. Simultaneous transmission is not possible, which makes it impossible to simultaneously obtain information about the transmitters, such as position, attitude, speed or acceleration, and thus also makes it difficult to analyse the relative transmitter positions to each other. Complex coordination of the signals is also necessary to prevent temporal overlap. Time synchronisation is only possible with a great deal of effort. This applies to all established localisation procedures such as time of arrival (TOA), round trip time of flight (RTOF) or time difference of arrival (TDOA). Similarly, continuous tracking of small shifts over the phase is not possible, which reduces accuracy. Other sensor systems, such as inertial measurement units (IMU), can only be synchronised with significant effort, as this requires another separate and synchronised communication system.

The method is also only possible with high hardware costs, as a wide frequency band requires an expensive transmitter. Many transmitters in particular consume a lot of energy. The realisation of energy self-sufficient transmitters is therefore associated with difficulties. To coordinate the transmitters, they usually also have a receiver. With additional, possibly broadband receivers, the hardware requirements and energy consumption are increased even further. Without receivers, a UWB approach in which many transmitters are located in a coordinated, simultaneous and time-stamped manner is only possible at great expense and is inefficient.

A code-division multiple access (CDMA) approach can be considered as an alternative to time interleaving. However, there are also difficulties here with many moving transmitters, as long codes limit the sampling rate and non-ideal signal shapes make implementation for UWB considerably more difficult. This approach also requires very complex transmitters.

The localisation method disclosed in DE 10 2019 110 512 A1 for localising at least one object using wave-based signals is also known. Narrow-band signals are analysed using spatially distributed phase measurements, so that directional information is determined instead of distance information. These signals can be modulated, for example to transmit data. Synchronisation of the transmitter is also not necessary.

A method is known that is disclosed in “S. Brückner, et al, ‘Phase Difference Based Precise Indoor Tracking of Common Mobile Devices Using an Iterative Holographic Extended Kalman Filter’, IEEE Open Journal of Vehicular Technology, vol. 3, pp. 55-67, January 2022”.

Similarly, from “E. Sippel et al, ‘Quasi-Coherent Phase-Based Localization and Tracking of Incoherently Transmitting Radio Beacons’, in IEEE Access, vol. 9, pp. 133229-133239, 2021, doi: 10.1109/ACCESS.2021.3115563” a method for localisation using a quasi-coherent holographic extended Kalman filter (QCHEKF) is known.

In order to detect movements of a body or individual body parts, optical localisation systems are often used, which are based on optical markers that have to be worn over clothing to ensure a line of sight to a plurality of infrared cameras. Alternatively, an inertial sensor system can be used to analyse the orientation of individual body parts in a skeleton model. The inherent disadvantage of this measuring principle is the limited accuracy and the lack of absolute position measurement in space.

Against this background, the object of the present invention is to improve the determination of the position, orientation and/or movement of one and, in particular, a plurality of beacons using one of said systems.

This object is achieved by the subject matter with the features of the independent claim 1. Advantageous further embodiments of the invention are the subject matter of the dependent claims.

Consequently, it is provided according to the invention that the system has at least one further beacon, wherein the frequency band of the transmitter of the further beacon or the frequency bands of the transmitters of the further beacons differ(s) from the frequency band of the transmitter of the beacon.

It is preferable to use a holographic extended Kalman filter (HEKF) for many transmitters with frequency interleaving or frequency division multiplex (FDM). Each transmitter has its own frequency band. For example, the carrier frequencies used in the frequency bands used have a frequency spacing of 4 MHz for a total band of 61 to 61.5 GHz.

Preferably, it is provided that the beacon can be arranged on an object or a living being or on an envelope of an object or a living being and the system has means designed in such a way that the position of the beacon can be determined in relation to the living being or the body envelope.

It is conceivable that the system further comprises a, preferably radio-based and/or wave-based, sensor system and/or an imaging measuring arrangement, wherein the system has means designed to control the sensor system and/or the imaging measurement arrangement in such a way that the sensor system and/or the imaging measurement arrangement can detect a position and/or movement of the beacon and/or the system has means designed to display the position of the beacon correctly in an image of the object or living being or the envelope of an object or living being.

In an advantageous embodiment, it is provided that the beacon further comprises a sensor, wherein the transmitter and the receiver are further designed to transmit data from the sensor to the receiver via waves.

In other words, preferably only the phase of the wave is used to determine the position and/or movement of the beacon. Data can therefore be transmitted via the amplitude of the wave using standard amplitude modulation methods. It is also conceivable that the phase of the wave is modulated, in particular if only phase differences are analysed to determine the position and/or movement of the beacon.

It is conceivable that the frequency bands are in a range between 61 and 61.5 Ghz and/or that the carrier frequencies of the frequency bands used have a frequency spacing of 4 MHz.

It is also conceivable that the frequency bands are in any frequency range and/or that the carrier frequencies of the frequency bands used have any frequency spacing. The frequency spacing is preferably such that the frequency bands do not overlap and/or interfere with each other.

It can be provided that the transmitter has an antenna, wherein the system has means designed to use the position of the antenna to determine the position and/or movement and to image the beacon.

It can also be provided that the system has means designed to synchronise the beacon and/or the transmitter of the beacon with other beacons and/or transmitters of beacons.

The determination of the position and/or the movement can also be referred to as localisation.

Preferably, it is not necessary to synchronise the transmitters with each other, as they can all transmit at any time without interfering with each other.

Synchronisation for relative evaluation between a plurality of transmitters, such as in gait analysis, is preferably carried out implicitly when receiving by simultaneous transmission of the waves and the same receiving hardware. This enables exactly simultaneous position information without additional effort. This is in particular advantageous for relative evaluation, e.g. of postures.

If an additional sensor is arranged on the beacon, the data transmission of the sensor's measurement signal, preferably with deterministic measurement, and the positioning of the beacon are preferably implicitly synchronised in time, as the same wave or signal is used for positioning and data transmission.

It can be provided that the beacon has an inertial sensor system designed to determine the orientation of the beacon in space.

It is conceivable that the receiver has means designed to receive the waves with a sampling rate greater than 10 kHz.

Significantly higher sampling rates, such as >10 kHz, are preferably possible, which can be advantageous for fast movements and complex analyses with machine learning, for example.

It is preferably provided that the system is a component of a sports, training, fitness tracking or fitness information system or is used for a diagnostic or therapeutic purpose in medicine, psychology or the health sector.

It is conceivable that the system comprises more than two beacons and/or more than one receiver.

Simultaneous, continuous measurement of the phase of the wave means that even small changes in the position of the beacon, e.g. when living beings shiver, can be easily detected. This is possible in particular with a quasi-coherent holographic extended Kalman filter (QCHEKF).

Advantageously, the system has more than one receiver, wherein the receivers preferably have a common frequency reference. Thus, the high requirement for phase stability of the oscillators used, which is necessary in the QCHEKF in the transmitter for the evaluation of absolute phases, is substituted by the constant phase position between the receivers. The relative phase relationships between at least two receivers can then be utilised by means of a quasi-coherent evaluation. This enables localisation with comparable accuracy to the QCHEKF with very stable oscillators, but with significant advantages in terms of costs and energy requirements due to very simple transmitters.

There is then the possibility of very simple transmitters, especially in terms of costs and energy requirements.

An additional measurement, such as imaging a body envelope on the receiver with largely the same hardware, is conceivable. This in turn is therefore implicitly synchronised with localisation through simultaneous data recording. The radio-based and/or wave-based sensors and/or the imaging measurement arrangement are thus preferably congruent with the hardware designed for localisation, in particular with the receiver, or integrated thereinto.

It is therefore conceivable that exactly the same antennas are used for localisation and imaging, as this allows the beacons to be mapped/plotted correctly in the image of the body envelope. This is preferably achieved without geometric calibration of the position of the beacons. Preferably, the position of the beacons in relation to the body is determined without calibration. This is advantageous in terms of ease of use.

Imaging and localisation can also be carried out simultaneously, e.g. via a simple-frequency multiplex.

The invention also relates to a method having a system according to the invention having the following steps:
a) providing a beacon;
b) detecting the position and/or movement of the beacon,
wherein a further beacon is provided, wherein the frequency band of the transmitter of the further beacon differs from the frequency band of the transmitter of the beacon.

Preferably, it is provided that the method further comprises the following steps:
c) generating an image of an object or living being or the envelope of the object or living being;
d) displaying the position of the beacon, preferably in the correct location, in the image of the living being or the body envelope.

It is conceivable that the method further comprises the following step:
e) transmitting data from the transmitter to the receiver.

It can also be provided that the method further comprises the following step:
f) determining the orientation of the beacon in space.

It can be provided that the method is used in a sports, training, fitness tracking or fitness information system or is used for a diagnostic or therapeutic purpose in medicine, psychology or the health sector.

The invention also relates to a computer program, comprising instructions that cause the system according to the invention to perform the method steps of a method according to the invention.

The invention also relates to a computer-readable medium, on which the computer program is stored.

The term envelope or body envelope is preferably understood as the interface that creates the boundary between the inside and outside of a living being's body. The outside is usually air or the atmosphere surrounding the living being, and the inside is the body or the material structures of the body. In many animals and in humans, the body envelope can be defined by the skin surface.

A beacon preferably refers to a unit consisting of a sensor, processing unit and emitting device with an integrated energy source. The energy source can be a rechargeable battery or a capacitor, for example, or can be formed or supplied by extracting energy from the environment, for example through energy harvesting. The object of the beacon is preferably the local detection of data and the corresponding processing of the data so that it can be transmitted to base stations via an emitting device.

Radio technology is preferably understood as a system that can transmit and receive signals using emitting and receiving devices, in particular antennas. The signal can be emitted optically, acoustically or, in particular, electromagnetically. The purpose of the signal transmission can be the transmission of information in the form of data to be transmitted from transmitter to receiver and/or the collection of localisation information.

Localisation can be understood as the determination of the position and/or orientation of an object, for example a beacon, in space, in particular three-dimensional space.

A base station is preferably a typically stationary unit whose primary object is to receive signals emitted by beacons. Furthermore, signals can be sent out to control beacons. The base station contains at least one receiving device and typically a processing unit for processing the data. It can be advantageous to connect a plurality of base stations to each other, in particular if they are used for localisation purposes.

It is also conceivable that the radio-based and/or wave-based sensor system is designed in such a way that movements of the body are detected with the aid of a beacon attached to the body surface.

It is also conceivable that a beacon comprises an inertial sensor system that determines the orientation of the beacon.

It is also conceivable that the radio-based and/or wave-based sensor technology is designed in such a way that it is used to determine the position of the sensor on the human body envelope and this measurement data is used to precisely assign the measurements of each beacon to specific body positions.

Preferably, an imaging measuring arrangement is provided that is suitable for generating an image of the body envelope as well as for receiving the radio signals of the beacons and displaying the positions of the beacons correctly in the image of the body envelope.

It is conceivable that the system, the method or the arrangement is used for a diagnostic or therapeutic purpose in medicine, psychology or the health sector.

At this point it is pointed out that the terms “a” and “one” do not necessarily refer to exactly one of the elements, although this is a possible embodiment, but can also denote a plurality of the elements.

Similarly, the use of the plural also includes the presence of the element in question in the singular and, conversely, the singular also includes several of the elements in question. Furthermore, all of the features of the invention described herein may be claimed in any combination or in isolation from each other.

### BRIEF DESCRIPTION OF THE FIGURES

Further advantages, features and effects of the present invention are shown in the following description of preferred exemplary embodiments with reference to the figures, in which the same or similar components are designated by the same reference numerals. In the figures:

FIG. 1: shows an embodiment of a system according to the invention.

FIG. 2: shows a further embodiment of a system according to the invention.

### DETAILED DESCRIPTION

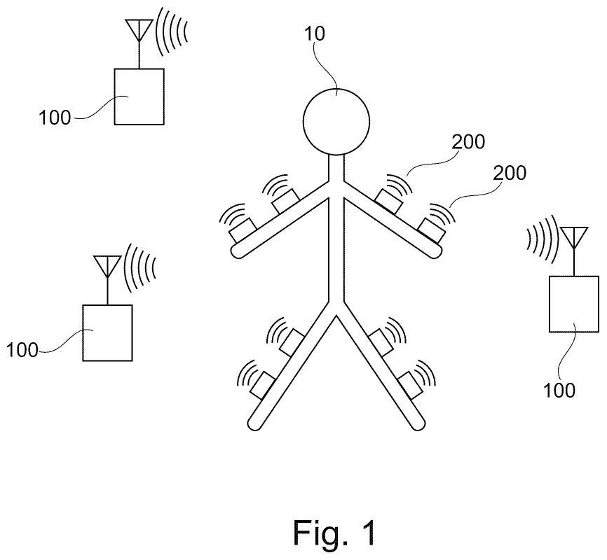

The system in FIG. 1 has one or more beacons 200, which are attached to a body envelope of a person 10. The beacons can have sensors. Typically, twelve beacons 200 distributed over the entire body are used. To increase the degree of detail, significantly more beacons 200 can also be attached. If the measuring range is restricted to certain regions of the body, the number of beacons 200 can also be significantly reduced.

The beacons 200 process the data in such a way that it can be transmitted via radio technology. One or more base stations 100 receive the signals and process them so that both the signals from the sensors are extracted and the position and/or location of the beacons 200 can be deduced. The advantage is that, for the first time, this enables the simultaneous localisation and transmission of sensor data via a common radio transmission channel.

A beacon 200 is attached to the body envelope, for example by means of an adhesive layer or an elastic band, and records parameters such as acceleration data. Further parameters such as orientation can be recorded by sensors contained in the beacon 200.

The use of electromagnetic waves in the frequency range from 3 MHz to 3 THz has proven to be advantageous. This includes, for example, the frequency bands of modern communication systems such as WLAN or the 5G or 6G mobile communications standard. The internationally standardised IMS frequency band from 61 to 61.5 GHz, for example, is also particularly suitable. This frequency band provides sufficient bandwidth to enable the use of a large number of beacons 200, for example by allowing them to be differentiated by the base station 100 using individual transmission frequencies. The use of electromagnetic waves in the frequency band mentioned proves to be favourable, in particular when phase-based localisation methods are used, as in DE 10 2019 110 512. The content disclosed in DE 10 2019 110 512 A 1 is hereby incorporated in full into the present description. In addition, electromagnetic waves in the frequency range mentioned can penetrate a variety of materials, such as clothing, with low losses.

If the method from DE 10 2019 110 512 A 1 is used, it is advantageous that each beacon 200 transmits its measurement signals in a separate frequency band, i.e. with an individual transmission frequency. This makes it easy for all beacons 200 to transmit simultaneously without interference. This is highly advantageous for localising and tracking highly dynamic movements, as the simultaneous transmission of all beacons 200 also allows the positions and vectorial velocities of all beacons 200 to be recorded simultaneously in a base station, thus eliminating the need for complex and error-prone time and motion correction calculation methods to compensate for different measurement times. The proposed preferred concept thus enables, on the one hand, optimal accuracy of the recorded body part positions, movements, and the entire body poses and body movements on the other hand, with comparatively little computing effort.

The radio transmission of the sensor data can be achieved, for example, by modulating the transmitted signal, for example by amplitude modulation, since this does not affect the localisation capability. The radiation device and processing unit of the receiver(s) can also be used to receive signals sent to the beacon 200. These can be control signals for configuring the beacon 200, for example. The power supply of the beacon 200 can be achieved, for example, by an energy source E integrated in the beacon 200, for example a rechargeable battery, capacitor or by obtaining energy from the environment, for example by energy harvesting.

One or more base stations 100 are used to receive the signals transmitted by the beacon 200. Several base stations, each with at least one and preferably a plurality of receiving antennas 100, are advantageous for three-dimensional localisation in space. This is the case in particular if the orientation of the beacons 200 changes due to movement of the body and a direct connection to all base stations 200 cannot be guaranteed at all.

In principle, all known localisation methods can be used to locate the position of the beacon 200, for example, the evaluation of the received power or the signal propagation time. However, the use of phase-based methods, which evaluate the phase angle of the received signal and can therefore be used independently of the signal modulation employed, is particularly advantageous.

A robust method is, in particular, the evaluation of the difference in receiving phase between different receiving devices. A particularly advantageous evaluation method is the method with a Kalman filter presented in the patent specification DE 10 2019 110 512 A1 or in US 2021/0389411 A1 as, unlike conventional methods, this method does not evaluate the angle of the received signal as an intermediate step. The aforementioned patent specification and all embodiments and methods contained therein are referred to in full in this document.

It is particularly advantageous if the arrangement described above is combined with an imaging sensor system based on a camera, depth camera, laser scanner or ultrasound, but in particular with an imaging radar system. Radars such as those used in security personnel scanners are used as imaging radar systems. In particular, multimodal sensor arrangements can also be considered. The advantage of this combination is that the absolute position of the beacons 200 on the body envelope is of great importance. The imaging sensor system used should therefore be able to image both the body envelope and the beacons 200 on the body envelope. Radar systems are particularly suitable for this purpose, as the beacons 200 can be localised and imaged using radar sensors even when they are covered by clothing.

A further extraordinarily advantageous embodiment results if the antennas and/or the electronic signal receiving devices of the imaging radar system are also used to receive the beacon signals. In this case, the imaging radar system and the beacons 200 should preferably operate in a common frequency band. The advantage of this embodiment is that the image of the body envelope and the position of the beacons 200 are captured in an identical reference coordinate system. Another advantage is that the shared use of hardware for different objects leads to a cost reduction of the overall system.

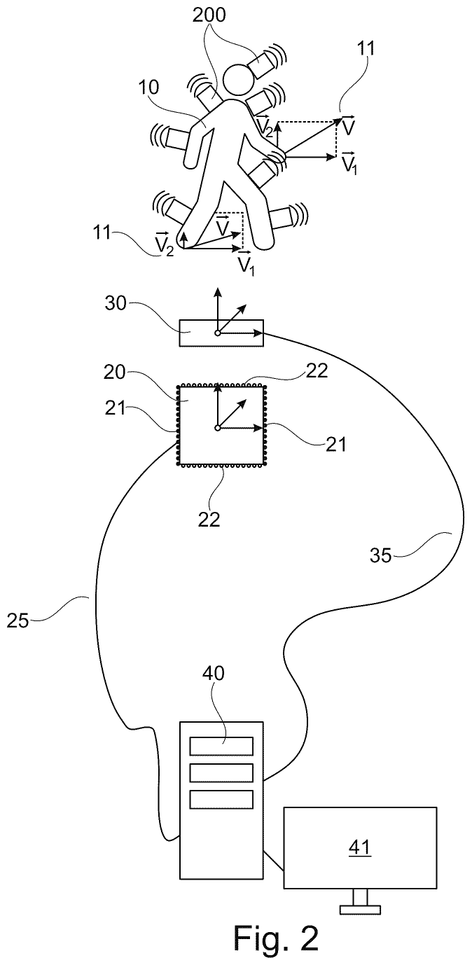

FIG. 2 shows an exemplary system or arrangement with a multimodal sensor arrangement for detecting the beacons 200. An imaging MIMO-FSK radar is shown as the primary modality 20 with a depth camera as the assisting modality 30, which are orientated one above the other. The MIMO-FSK radar or the primary modality 20 preferably has receiving antennas 21 and transmitting antennas 22.

For example, the object 10 in FIG. 2 is a moving person or body part and is provided with beacons 200. Individual points on the person or body part move in FIG. 2 with a velocity vector V with the reference numeral 11, which can be broken down into the Cartesian components V1 and V2.

The depth camera or assisting modality 30 is connected to a computer 40 by a link 35 via which the distance features of the object 10 detected by the depth camera or assisting modality 30 are transmitted.

The MIMO-FSK radar or primary modality 20 is connected to the computer 40 by a link 25 via which the speed and range features of the object 10 detected by the MIMO-FSK radar or primary modality 20 and the beacon signals are transmitted.

The computer 40 can be connected to a monitor 41 on which the results of the algorithms executed on the computer 40 for determining the image and movement of the object 10 and for determining the position of the beacons 200 on the body envelope and the movement of the beacons 200 can be displayed.

1. System for determining the position, the orientation and/or the movement of a beacon, said system having at least one receiver and one beacon, wherein the beacon comprises a transmitter, wherein the transmitter of the beacon is designed to emit electromagnetic waves in a frequency band and the receiver has means designed to receive the waves and to determine a position, orientation and/or movement of the beacon therefrom, wherein the system has at least one further beacon, wherein the frequency band of the transmitter of the further beacon or the frequency bands of the transmitters of the further beacons differ(s) from the frequency band of the transmitter of the beacon.

2. System according to claim 1, wherein the beacon can be arranged on an object or a living being or on an envelope of an object or a living being and the system has means designed in such a way that the position of the beacon can be determined in relation to the living being or the body envelope.

3. System according to claim 2, wherein the system further comprises a sensor system and/or an imaging measuring arrangement, wherein the system has means designed to control the sensor system and/or the imaging measurement arrangement in such a way that the sensor system and/or the imaging measurement arrangement can detect a position and/or movement of the beacon and/or the system has means designed to display the position of the beacon correctly in an image of the object or living being or the envelope of an object or living being.

4. System according to claim 1, wherein the beacon further comprises a sensor, wherein the transmitter and the receiver are further designed to transmit data from the sensor to the receiver via waves.

5. System according to claim 1, wherein the frequency bands are in a range between 61 and 61.5 Ghz and/or in that the carrier frequencies used have a frequency spacing of 4 MHz in the frequency bands used.

6. System according to claim 1, wherein the transmitter has an antenna, wherein the system has means designed to use the position of the antenna to determine the position and/or movement and to image the beacon.

7. System according to claim 1, wherein the system has means designed to synchronise the beacon and/or the transmitter of the beacon with other beacons and/or transmitters of beacons.

8. System according to claim 1, wherein the beacon has an inertial sensor system designed to determine the orientation of the beacon in space.

9. System according to claim 1, wherein the receiver has means designed to receive the waves with a sampling rate greater than 10 kHz.

10. System according to claim 1, wherein the system is a component of a sports, training, fitness tracking or fitness information system or is used for a diagnostic or therapeutic purpose in medicine, psychology or the health sector.

11. System according to claim 1, wherein the system comprises more than two beacons and/or more than one receiver.

12. Method having a system according to claim 1, having the following steps:
a) providing a beacon;
b) detecting the position and/or movement of the beacon,
wherein
a further beacon is provided, wherein the frequency band of the transmitter of the further beacon differs from the frequency band of the transmitter of the beacon.

13. Method according to claim 12, wherein the method further comprises the following steps:
c) generating an image of an object or living being or the envelope of the object or living being;
d) displaying the position of the beacon, in the correct location, in the image of the living being or the body envelope.

14. Method according to claim 12, wherein the method further comprises the following step:
e) transmitting data from the transmitter to the receiver.

15. Method according to claim 12, wherein the method further comprises the following step:
f) determining the orientation of the beacon in space.

16. Method according to claim 12, wherein the method is used in a sports, training, fitness tracking or fitness information system or is used for a diagnostic or therapeutic purpose in medicine, psychology or the health sector.

17. Computer program, comprising instructions that cause a system to perform the method steps of claim 12, wherein the system is for determining the position, the orientation and/or the movement of a beacon, said system having at least one receiver and one beacon, wherein the beacon comprises a transmitter, wherein the transmitter of the beacon is designed to emit electromagnetic waves in a frequency band and the receiver has means designed to receive the waves and to determine a position, orientation and/or movement of the beacon therefrom, wherein the system has at least one further beacon, wherein the frequency band of the transmitter of the further beacon or the frequency bands of the transmitters of the further beacons differ(s) from the frequency band of the transmitter of the beacon.

18. Computer-readable medium on which the computer program according to claim 17 is stored.

19. System according to claim 3, wherein the sensor system is radio-based and/or wave-based sensor system.
